(19) United States
(12) Patent Application Publication
(10) Pub. No.: US 2025/0133515 A1
(43) Pub. Date: Apr. 24, 2025

(54) ON-DEMAND SSB POWER AND REPETITION FACTOR REQUEST

(71) Applicant: QUALCOMM Incorporated, San Diego, CA (US)

(72) Inventors: Ahmed Attia ABOTABL, San Diego, CA (US); Diana MAAMARI, San Diego, CA (US); Navid ABEDINI, Basking Ridge, NJ (US)

(21) Appl. No.: 18/493,739

(22) Filed: Oct. 24, 2023

(51) Int. Cl. H04W 56/00

(52) U.S. Cl. CPC H04W 56/0015; H04W 56/0095

(57) ABSTRACT

This disclosure provides methods, components, devices, and systems for optimizing energy efficiency and network performance in cellular networks through dynamic adaptation of transmission parameters for synchronization signal blocks (SSBs) and system information block type 1 (SIB1) transmissions initiated by user equipment (UE) requests. Some aspects more specifically relate to providing UE-assisted information over an uplink wake-up signal (UL-WUS) to optimize support of on-demand SSBs or SIB1s. In some examples, a UE sends an uplink signal to a network entity requesting transmission of at least one of an SSB or an SIB1, with the uplink signal indicating a transmission parameter for the SSB or the SIB1, such as transmission power or repetition factor. In response to the uplink signal, the network entity sends the SSB or the SIB1 associated with the transmission parameter based at least in part on the uplink signal, resulting in improved energy efficiency and network performance.

### TECHNICAL FIELD

The present disclosure relates to wireless communication, and more particularly, to dynamic adaptation of transmission parameters for synchronization signal blocks (SSBs) and system information block type 1 (SIB1) transmissions initiated by user equipment (UE) requests.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a user equipment (UE). The apparatus includes one or more memories, and one or more processors each communicatively coupled with at least one of the one or more memories. The one or more processors, individually or in any combination, are operable to cause the apparatus to send an uplink signal to a network entity requesting transmission of at least one of a synchronization signal block (SSB) or a system information block type 1 (SIB1), with the uplink signal indicating a transmission parameter for the at least one of the SSB or the SIB1, and the transmission parameter being at least one of a transmission power or a repetition factor. Furthermore, the apparatus is operable to obtain the at least one of the SSB or the SIB1 associated with the transmission parameter based at least in part on the uplink signal.

Another innovative aspect of the subject matter described in this disclosure may be implemented in a method of wireless communication performable at a UE. The method includes sending an uplink signal to a network entity requesting transmission of at least one of a SSB or a SIB1, with the uplink signal indicating a transmission parameter for the at least one of the SSB or the SIB1, and the transmission parameter being at least one of a transmission power or a repetition factor. The method also includes obtaining the at least one of the SSB or the SIB1 associated with the transmission parameter based at least in part on the uplink signal.

Another innovative aspect of the subject matter described in this disclosure may be implemented in an apparatus for wireless communication, where the apparatus is a network entity. The apparatus includes one or more memories, and one or more processors each communicatively coupled with at least one of the one or more memories. The one or more processors, individually or in any combination, are operable to cause the apparatus to obtain an uplink signal from a UE requesting transmission of at least one of a SSB or an SIB1, with the uplink signal indicating a transmission parameter for the at least one of the SSB or the SIB1, and the transmission parameter being at least one of a transmission power or a repetition factor. Furthermore, the apparatus is operable to send the at least one of the SSB or the SIB1 associated with the transmission parameter based at least in part on the uplink signal.

Another innovative aspect of the subject matter described in this disclosure may be implemented in a method of wireless communication performable at a network entity. The method includes obtaining an uplink signal from a UE requesting transmission of at least one of a SSB or an SIB1, with the uplink signal indicating a transmission parameter for the at least one of the SSB or the SIB1, and the transmission parameter being at least one of a transmission power or a repetition factor. Furthermore, the method includes sending the at least one of the SSB or the SIB1 associated with the transmission parameter based at least in part on the uplink signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a call flow diagram between a UE and a base station.

FIG. 5 is a flowchart of a method of wireless communication performable at a UE.

FIG. 6 is a flowchart of a method of wireless communication performable at a network entity.

FIG. 7 is a diagram illustrating an example of a hardware implementation for an example apparatus.

FIG. 8 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the subject matter described in this disclosure relate to optimizing energy efficiency and network performance in cellular networks, and more particularly to dynamic adaptation of transmission parameters for synchronization signal blocks (SSBs) and system information block type 1 (SIB1) transmissions initiated by user equipment (UE) requests. Some aspects more specifically relate to providing UE-assisted information over an uplink wake-up signal (UL-WUS) to optimize support of on-demand SSBs or SIBis, such as a requested transmission power or a requested repetition factor for the SSBs or SIBis, to enhance network energy savings and overall network performance. In various examples, a UE sends an uplink signal to a network entity requesting transmission of at least one of an SSB or an SIB1, with the uplink signal indicating a transmission parameter for the at least one of the SSB or the SIB1, such as transmission power or repetition factor. In response to the uplink signal, the network entity sends the at least one of the SSB or the SIB1 associated with the transmission parameter based at least in part on the uplink signal. By allowing the UE to request specific transmission parameters, such as transmission power or repetition factor, for on-demand SSBs or SIB1s, the network may dynamically adapt its transmissions based on actual user demands and network conditions, providing more efficient network resource utilization and improved energy savings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

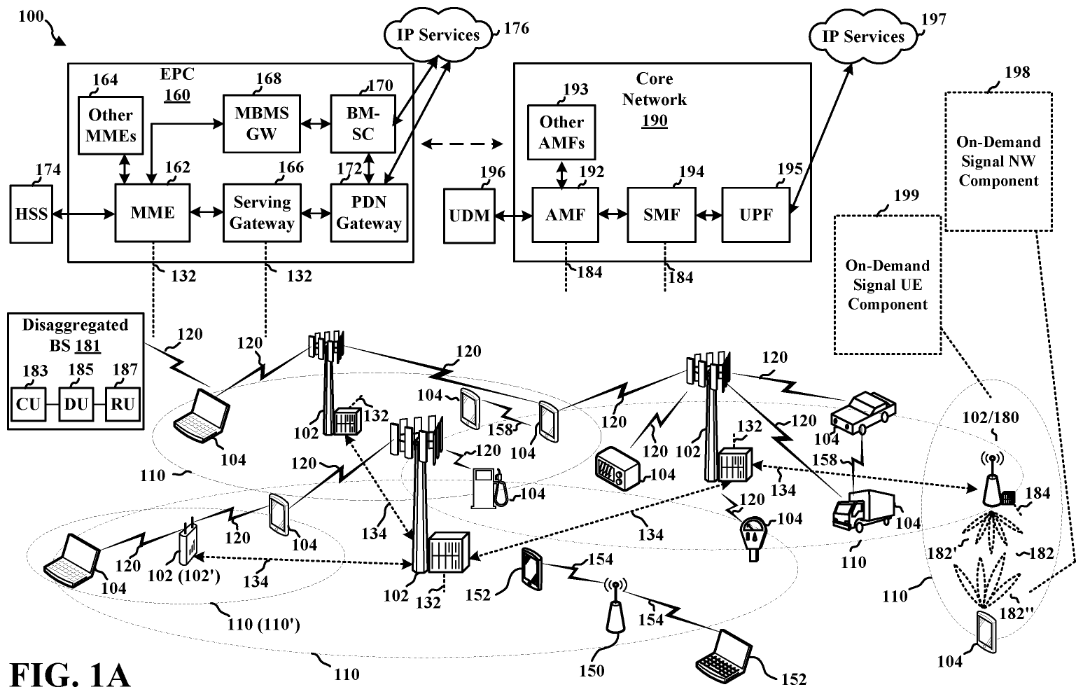

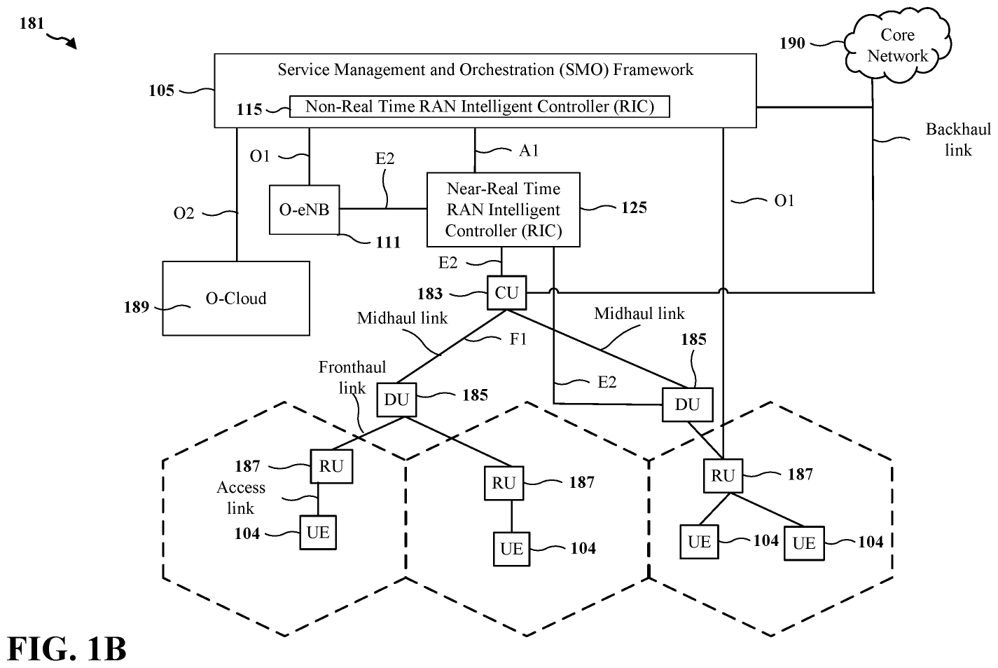

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an 02 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104 may include an on-demand signal UE component 198 that is configured to send an uplink signal to a network entity requesting transmission of at least one of a synchronization signal block (SSB) or a system information block type 1 (SIB1), with the uplink signal indicating a transmission parameter for the at least one of the SSB or the SIB1, such as transmission power or repetition factor. The on-demand signal UE component 198 is also configured to obtain the at least one of the SSB or the SIB1 associated with the transmission parameter based at least in part on the uplink signal.

Furthermore, in certain aspects, a network entity such as base station 102/180, disaggregated base station 181, or a component of disaggregated base station 181 such as CU 183, DU 185, or RU 187, may include an on-demand signal network (NW) component 199 that is configured to obtain the uplink signal from the UE, which requests transmission of at least one of an SSB or an SIB1 and indicates a transmission parameter for the at least one of the SSB or the SIB1, such as transmission power or repetition factor. The on-demand signal NW component 199 is also configured to send the at least one of the SSB or the SIB1 associated with the transmission parameter based at least in part on the uplink signal.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

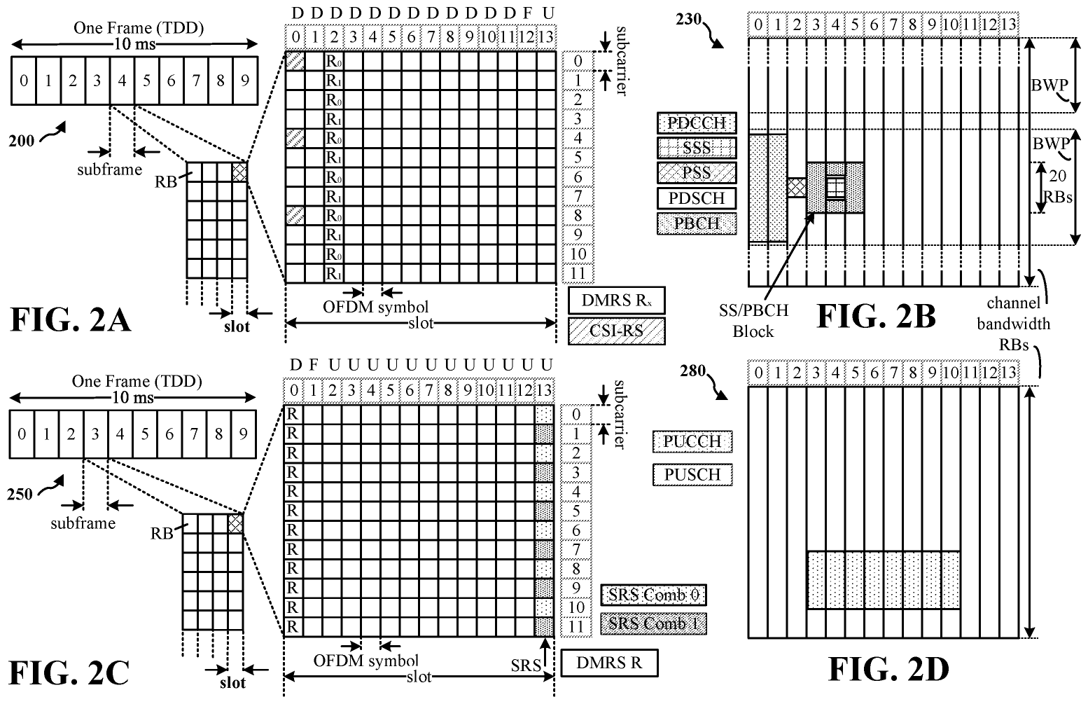

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

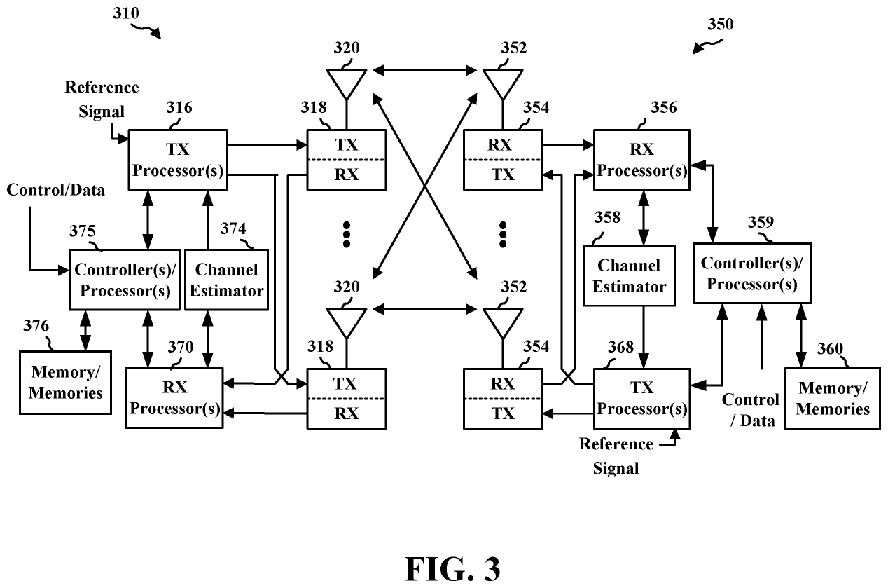

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with on-demand signal UE component 198 of FIG. 1A.

At least one of the one or more TX processors 316, the one or more RX processors 370, and the one or more controller/processors 375 may be configured to perform aspects in connection with on-demand signal NW component 199 of FIG. 1A.

Cellular networks utilize a significant amount of energy to operate, including powering base stations, data centers, and other network equipment. Energy consumption is thus an important aspect to consider when designing, deploying, and maintaining a cellular network, as it directly impacts the operational expenses and environmental footprint. For example, energy consumption may account for a significant percentage of the total expenses of running a cellular network, which is a substantial portion of the overall costs. This makes it an important factor for network operators to consider when planning and managing their networks.

Most network energy consumption comes from the RAN, which is responsible for connecting UEs to the core network. In 5G networks, RAN accounts for approximately half of the total energy consumption due to the increased density of base stations, higher data rates, and more advanced technologies used compared to previous generations. Given the high energy consumption and associated costs, it is important for cellular networks to incorporate energy-saving features. These features can help reduce energy consumption, lower operational expenses, and minimize the environmental impact of the network. By adopting energy-efficient technologies and practices, network operators may make their networks more sustainable and cost-effective. This is significant for the widespread adoption and expansion of cellular networks, especially as 5G technology continues to evolve and grow.

Accordingly, studies on network energy savings for NR technology have been conducted. Such studies tend to focus on three main aspects, including developing an energy consumption model for base stations, establishing an evaluation methodology for assessing network energy consumption and energy savings gains, and exploring and identifying techniques that can enhance network energy savings in terms of both base station transmission and reception. For example, an energy consumption model may be adapted from power consumption modeling and evaluation methodologies that provide guidelines for evaluating energy efficiency in cellular networks. The model may consider factors such as power amplifier efficiency, the number of transmit/receive units (T×RU), base station load, sleep states, transition times, and reference parameters or configurations. An evaluation methodology may consider the impact on network and user performance, such as spectral efficiency, capacity, user plane latency, handover performance, call drop rate, initial access performance, and Service Level Agreement (SLA) assurance-related Key Performance Indicators (KPIs). The evaluation methodology may not focus on a single KPI and may reuse existing KPIs or develop new KPIs. Techniques that may enhance network energy savings in terms of both base station transmission and reception may include those which achieve efficient operation dynamically or semi-statically, and finer granularity adaptation of transmissions or receptions. Such network energy saving techniques may be applied in time, frequency, spatial, and power domains, with potential support or feedback from UE, and potential UE assistance information as well as information exchange or coordination over network interfaces. Other techniques may not be precluded.

Based on these studies, various network energy saving efforts have been considered. One effort or technique considered in the context of network energy saving is dynamic adaptation of the spatial and power domains, which focuses on improving energy efficiency by dynamically adjusting spatial and power domain parameters in the network. This can help optimize energy consumption based on current network conditions and user demands. Another effort or technique that is considered explores the use of Discontinuous Transmission (DTX) or Discontinuous Reception (DRX) techniques in cellular networks, also referred to as cell DTX or cell DRX. These techniques allow cells to enter low-power states when there is no data to transmit or receive, thus saving energy. A further technique for saving energy at the network side is application of on-demand SSBs, which allow for initial access and synchronization in cellular networks. In an on-demand SSB approach, SSBs are transmitted only when needed, rather than continuously, which can help reduce energy consumption in the network. This approach may be applied for SSBs as well as for System Information Block 1 (SIB1).

In another approach, SSB-less carriers may be applied in carrier aggregation (CA) to save network energy. However, while SSB-less carriers may be supported in intra-band CA for both Frequency Range 1 (FR1) and Frequency Range 2 (FR2), and while inter-band CA with SSB-less carriers may be supported for FR1 only, this feature may be limited in deployments due to feasibility requirements on co-location, Maximum Relative Transmit Power Difference (MRTD), and band combination. Moreover, extending the feature to other frequency ranges such as FR2 may be challenging due to beam management operations.

At least in part due to these limitations, discovery reference signals have been introduced, along with on-demand SSBs for network energy saving in CA operation, to cover scenarios where CA using SSB-less carriers is not feasible or to extend inter-band CA with SSB-less carriers to other frequency ranges. A discovery reference signal (DRS) is a reference signal which the base station may transmit for the UE to maintain downlink synchronization with the network. For instance, the DRS may allow the UE to determine frame and frequency boundaries of an on-demand SSB. Since a DRS may be applied for synchronization purposes similar to an SSB but does not include data in contrast to an SSB, a DRS may in some cases be referred to as a simplified SSB or a light SSB. Thus, a UE may apply a DRS for Radio Resource Management (RRM) measurement, while the UE may apply an on-demand SSB for time/frequency (T/F) synchronization and multi-beam operation.

Given the network energy savings that may be achieved via on-demand SSBs, it would be helpful to specify enhancements to support DRS or on-demand SSB in secondary cell(s) in CA or neighboring cell(s) for RRM in a UE connected state, or to support triggering of on-demand SSBs by an uplink signal from the UE or by network coordination. Moreover, it would be helpful to support application of DRS or on-demand SSBs or SIBis for UE operation (e.g., cell reselection) in an idle or inactive state of a UE.

To one or more of these ends, aspects of the present disclosure provide for optimized support of on-demand SSBs or SIBis via providing of UE assistant information over an uplink wake-up signal (UL-WUS) to improve network energy savings. In these aspects, a UE may send an UL-WUS to request the transmission of either an SSB or an SIB1 or both. The UL-WUS transmission may indicate a favored direction for the SSB or SIB1, which may be initially based on UE detection of a light SSB or DRS. For instance, the UL-WUS may request one or more certain transmission beams for the SSB or SIB1 corresponding to best beam(s) of a prior DRS, such as the DRS beam(s) associated with the highest signal strength(s), and the base station may refrain from performing an SSB or SIB1 beam sweep as a result when it transmits the on-demand signal on the requested beam(s). The UL-WUS may also convey additional information, either implicitly or explicitly, in various aspects. For example, the UL-WUS may request SSB or SIB1 transmission with a potential transmission power or power back-off, which may assist the network in saving energy if high SSB or SIB1 transmission power is not needed for example, or with a potential repetition factor, which may assist the network in saving energy if a large number of repetitions of SSBs or SIB1 is not needed for example, or with a combination of the foregoing information. For instance, in one aspect, the UE may provide an implicit or explicit recommendation to the base station to transmit an SSB or a SIB-1 or both with a certain power. This may lead to potential power savings if the requesting UE is close to the cell center, since UEs closer to the cell center may request lower SSB transmit power, while UEs farther away from the cell center may request greater transmit power, a power boost, or inter-slot combining of SSBs or SIB1s. Alternatively or additionally, in another aspect, the UE may provide an implicit or explicit recommendation to the base station which requests certain SSB or SIB-1 repetitions. These repetitions may help the requesting UE perform reception (Rx) beam refinement or Rx combining, improving the overall network performance. Thus, network performance and energy efficiency may be optimized.

In some examples, the UE may request a recommendation for the SSB or SIB-1 transmission power, either implicitly or explicitly. The recommendation may be based on measurements such as the RSRP of a DRS or other reference signal, a location of the UE, a coverage area of the base station, or other factors. This approach may help optimize SSB or SIB-1 transmission power and improve network energy efficiency. The network may choose to transmit more than just the requested SSB beam, either based on the UE request or the network's decision. The UE can request SSB or SIB-1 power for one or a subset of requested or transmitted beams, and the power values may be from a predefined set. The network may determine whether or not to follow the UE's recommendation, and the actual power value may be indicated in the payload of the SSB or SIB-1 block, such as the PBCH for an SSB. Allowing the UE to determine the transmission power of the SSB from its payload is significant since many other measurements depend on SSBs, and the SSB power acts as a reference for power of other signals or channels such as PDSCH.

In some examples, the UE may implicitly or explicitly request a repetition factor for the requested SSB or SIB-1 or both to improve network performance or UE reception quality through Rx beam refinement and Rx combining. The UE may send a repetition factor request indicating a reason of Rx beam refinement or a reason of Rx combining. The UE may determine to request repetition of an SSB or SIB-1 on a same beam multiple times using different reception beams to determine the best Rx beam for the particular transmission beam of the SSB or SIB-1. The UE may implicitly request the repetition factor using different uplink transmission occasions, or the UE may explicitly request the repetition factor using one or more bits in the request itself. The UE may request a repetition factor from a predefined set of repetition factors, in some cases based on whether it is to perform Rx beam refinement or Rx combining, and the network may determine the number of repetitions to apply based on an RRC configuration. SSB or SIB-1 repetitions may occur in different domains such as time or frequency depending on the frequency range of the SSB or SIB-1, and the UE may request repetitions for a single or multiple SSB or SIB-1 beams. The SSB or SIB-1 repetitions may be consecutive repetitions, where repetitions of one SSB beam occur before repetitions of another SSB beam, or they may be inconsecutive repetitions, where repetitions of SSB beams are interleaved with each other and non-transmitted SSB repetition occasions and transmitted via multiple beam sweeps.

In some examples, multiple UEs may request SSB repetitions simultaneously, which in turn may lead to the network deciding how to handle the requests. In one case, the base station may handle such requests by always transmitting the SSB or SIB-1 with a maximum configured repetition factor. Alternatively, in another case, the base station may more efficiently transmit the SSB or SIB-1 according to a maximum number of requested repetitions between the UEs. In the latter case, the base station may also provide additional information to the UEs regarding the maximum number of requested repetitions, such as through a PBCH payload, DCI, or PDSCH, so that the UEs may determine the greatest repetition factor they can expect. This information allows the UEs to be aligned in their information regarding repetition factor configurations. In one example, the network may transmit repetitions of SSBs (or SIB-1s) with sufficient time in between repetition occasions such that UEs may be able to decode the PBCH (or PDSCH) payload and identify the indicated number of repetitions in the SSB or SIB-1. In another example, the network may transmit a DCI or PDSCH indicating information regarding the repetition factor or transmission power of the SSBs or SIB-1s. For instance, the network may transmit a DCI in response to a UCI from the UE indicating a requested transmission power or repetition factor.

In some examples, the UE may request an SSB or SIB-1 transmission power or repetition factor using a random access channel (RACH) preamble transmission. In response to this preamble transmission, the base station may utilize a random access response (RAR) window associated with the RACH preamble and carrying a message 2 DCI which conveys information about the network transmission power and repetition factor for on-demand SSB or SIB-1 transmissions. The base station may modify one or more fields of the DCI to configure the DCI to carry information about the power, repetition factor, or other transmission parameter of the SSB or SIB-1. For example, the base station may configure the frequency domain resource assignment of the DCI to be set to all zeros to indicate its information pertains to an on-demand SSB or SIB-1. Thus, the UE may determine that the DCI does not contain UL grant information for a message 3 PUSCH transmission in random access, but rather on-demand SSB or SIB-1 information. The base station may also configure a different field of the DCI, such as modulation and coding scheme, to indicate the transmission power, repetition factor, or other transmission parameter applied for the SSB or SIB-1.

In some examples, the UE may implicitly or explicitly indicate the requested SSB or SIB-1 power or repetition factor for on-demand transmissions. In one example, the UE may send implicit indications of power, repetition factor, or other transmission parameter using different UL-WUS occasions or RACH preamble groups. For example, in a network having 64 RACH preambles divided into four RACH preamble groups, the UE may implicitly indicate a different repetition factor or transmission power depending on which of the four preamble groups from where the UE selected its preamble. In another example, the UL-WUS may be uplink control information (UCI), and the UE may send explicit indications of power, repetition factor, or other transmission parameter via a payload or sequence of bits in the UCI. These different methods provide flexibility in how the UE may communicate its requests to the network, potentially improving network performance and energy efficiency.

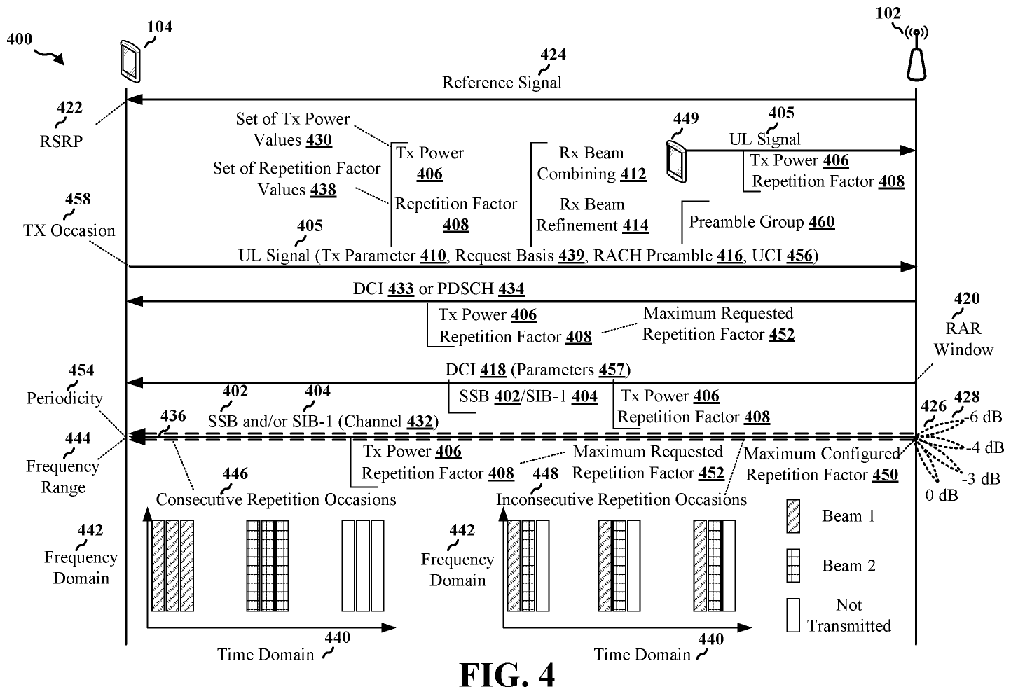

FIG. 4 illustrates an example 400 of a call flow between UE 104 and base station 102. Example 400 illustrates various aspects related to power or repetition recommendations for on-demand SSB 402 or SIB1 404 for improving network energy savings. In these aspects, the UE may request via an uplink signal 405 a recommendation for a transmission power 406 or a repetition factor 408 of an SSB 402 or SIB-1 404, or a combination of these or other transmission parameters 410, either implicitly or explicitly. The power recommendation may help optimize the SSB 402 or SIB-1 404 transmission power 406 based on actual network conditions and user demands, leading to improved energy efficiency. The repetition factor 408 recommendation may help the UE perform receive (Rx) combining 412 and beam refinement 414, which can improve network performance. Multiple UEs may simultaneously request different SSB 402 repetition factor 408 recommendations, which the network may handle in different manners. The UE may also send its power 406 or repetition factor 408 recommendation in the form of a random access channel (RACH) preamble 416, in response to which preamble the network may confirm the transmission power 406 and repetition factor 408 for on-demand SSB 402 or SIB-1 404 transmissions using a DCI 418 in a Random Access Response (RAR) window 420. The UE may request a specific transmission power 406, repetition factor 408, or other transmission parameter 410 for an on-demand SSB 402 or SIB-1 404 implicitly via the transmission occasion carrying its recommendation, implicitly via a RACH preamble group including a RACH preamble 416 constituting its recommendation, or explicitly via a payload in UCI.

In one example, the UE 104 may base its power recommendation in uplink signal 405 on a measured Reference Signal Received Power (RSRP 422) of a DRS or other reference signal 424, for example. This measurement may provide the UE with information about its received signal strength, which may be used to suggest an appropriate SSB or SIB-1 transmission power 406. In another example, when the network receives an SSB or SIB-1 demand, it may determine to follow the UE's request by sending the requested beam, or the base station may transmit more than just a requested SSB beam 426 or SIB-1 beam 428, either based on UE request for multiple beams 426, 428 or based on network decision. The UE may request the SSB or SIB-1 power 406 of one beam 426, 428, multiple requested beams 426, 428, or one or a subset of multiple transmitted or available beams 426, 428. In another example, the SSB or SIB-1 power request in uplink signal 405 may be from a pre-defined set of values 430, such as {0, −3 dB, −4 dB, −6 dB}. For instance, the request may include an index to a power value in the predefined set of values 430, and the base station may determine the power 406 requested from the index. This allows for a standardized approach to power recommendations, simplifying the communication between the UE and the network. In another example, the network response to the recommendation may follow the UE power recommendation, or alternatively it may not follow the UE power recommendation. The network may not follow the UE power recommendation if it instead follows a different UE's power recommendation, or due to network decision. Thus, the network response may be based at least in part on, but not necessarily entirely on, the UE's recommendation in uplink signal 405. To assist the UE in determining what power 406 is being used for subsequent measurements, the actual power value of the SSB 402 or SIB-1 404 beam may be indicated in a channel 432 of the block, such as the PBCH payload of the corresponding SSB 402 or a PDSCH payload of the SIB-1 404. Alternatively, the power 406 may be indicated in a DCI 433 or a PDSCH 434 as discussed below.

When a UE 104 requests an SSB 402 or a SIB-1 404, the UE may intend to perform Rx beam refinement 414 or Rx combining 412, and so the UE may request the base station 102 to transmit the same SSB or SIB-1 beam 426, 428 more than once. The total number of transmissions, including the original transmission and repetitions 436 of the original transmission, may be referred to as a repetition factor 408. In one example, the UE may request in uplink signal 405 a repetition factor 408 for the requested SSB 402 or SIB-1 404 from a predefined set of possible factors 438, such as {1, 2, 4, 8}. In one example, the UE may request in uplink signal 405 a certain number of repetitions 436 for a given beam 426, 428 of an SSB 402 or SIB-1 404 for a given basis 439, such as Rx beam refinement 414 or Rx combining 412. The UE may also indicate its basis 439 for repetition (e.g., for Rx combining 412 or Rx beam refinement 414) in the request, and the network may determine the number of repetitions 436 based on an RRC configuration. In one example, the SSB 402 or SIB-1 404 repetitions 436 may occur in a time domain 440 or a frequency domain 442. For instance, the repetitions 436 may occur in the time domain 440 when a frequency range 444 of the SSB 402 or SIB-1 404 is Frequency Range 2 (FR2) or Frequency Range 3 (FR3) or other suitable frequency range for time domain repetitions, in the frequency domain 442 when the frequency range 444 is Frequency Range 1 (FR1) or other suitable frequency range for frequency domain repetitions, or both in the time domain 440 and the frequency domain 442. The base station may determine which domain in which to apply repetitions 436 based on the frequency range 444. In one example, the UE may request the repetition 436 of a single SSB or SIB-1 beam 426, 428 or more than one SSB or SIB-1 beam 426, 428, where each SSB or SIB-1 beam may have a same repetition factor 408 or different repetition factors 408 or a combination of same and different repetition factors 408.

In another example, the repetitions 436 may take one of two options, including sequential or consecutive repetitions 446, or interleaved, beam swept or inconsecutive repetitions 448. In sequential repetitions 446, repetitions 436 of one SSB or SIB-1 beam 426, 428 may occur before repetitions 436 of another SSB or SIB-1 beam 426, 428 such as illustrated in FIG. 4. This includes repetition occasions where an SSB 402 or SIB-1 404 may not be transmitted, for example, due to the base station 102 not activating these beams or the UE 104 not requesting these beams. In interleaved repetitions 448, a repetition 436 of one SSB or SIB-1 beam 426, 428 may occur followed by a repetition 436 of another SSB or SIB-1 beam 426, 428, before a further repetition 436 of the former SSB 402 or SIB-1 404 beam occurs. This similarly includes repetition occasions where an SSB 402 or SIB-1 404 may not be transmitted such as illustrated in FIG. 4. While the illustrated example includes three repetitions 436 per SSB 402 or SIB-1 404, it should be understood that other numbers or quantities of repetitions 436 may be requested or applied in other examples.

In some examples, an UL-WUS such as uplink signal 405 could be requested by one UE 104 or multiple UEs 104, 449 simultaneously. In the case of one UE, or in the case of more than one UE requesting the same repetition factor 408, the base station 102 may satisfy the UE request(s) without conflict. In the case of more than one UE with different requests, for example, if one UE 104 requests an SSB 402 or SIB-1 404 with a repetition factor 408 of two for Rx combining 412 and another UE 449 requests the same beam with a repetition factor 408 of four, then the base station 102 may inform, indicate, or otherwise allow the UEs 104, 449 to determine which repetition factor 408 is being applied. In one example, upon receiving a request in uplink signal 405 from a UE, the base station 102 may transmit the SSB 402 or SIB-1 404 according to a maximum configured repetition factor 450. Thus if in one example the predefined set of possible factors 438 is {1, 2, 4, 8}, the base station may apply the maximum of eight repetitions regardless of the repetition factors 408 indicated in UL signals 405 from UEs 104, 449. In another example, the base station may transmit according to a maximum number of requested repetitions 452 (as opposed to a maximum configured repetition factor). Thus in the aforementioned example where the predefined set of possible factors 438 is {1, 2, 4, 8}, one UE requests a repetition factor of two, and another UE requests a repetition factor of four, the base station may apply the requested maximum of four repetitions indicated in UL signals 405 from UEs 104, 449. To allow the UEs to determine the repetition factor 408 applied, the base station may indicate the maximum number of requested repetitions 452 in a payload of the block (e.g., PBCH for SSB 402 or PDSCH for SIB-1 404), and the base station may transmit these repetitions 436 at a periodicity 454 such that sufficient time between repetitions 436 exists to allow the UEs to decode the PBCH or PDSCH payload and determine the indicated number of repetitions 436. Alternatively, the base station may first transmit either DCI 433 or PDSCH 434 indicating information about the repetition factor 408 or the transmission power 406 before sending the SSB 402 or SIB-1 404. For instance, the UE 104 may transmit uplink control information (UCI 456) in the uplink signal 405 requesting a certain transmission power 406 or repetition factor 408 for the SSB 402 or SIB-1 404, and the base station may respond with DCI 433 or PDSCH 434 indicating the requested or applied parameter for the on-demand signal.

In some examples, the UE 104 may transmit a UL-WUS such as uplink signal 405 that includes RACH preamble 416, and the base station 102 may responsively transmit DCI 418 within RAR window 420 that indicates the transmission parameter 410 to be applied for a subsequent SSB 402 or SIB-1 404. In one example, the UE may request in uplink signal 405 an SSB or SIB-1 transmission power 406 or repetition factor 408 for the on-demand signal using a preamble transmission, and the base station 102 may transmit DCI 418 within RAR window 420 corresponding to the preamble transmission. The DCI 418 may indicate the network transmission power 406 and repetition factor 408 to be applied to the on-demand signal. Since this DCI 418 scrambled with a Random Access Radio Network Temporary Identifier (RA-RNTI) generally carries information about an uplink grant for a message 3 PUSCH transmission in RACH, the base station may configure one or more of the DCI's fields or parameters 457 to indicate that the DCI 418 is not an UL grant but that an on-demand SSB 402 or SIB-1 404 will instead follow. For example, the base station may configure an all-zeros value in one of the fields or parameters 457a of DCI 418, such as the Frequency Domain Resource Allocation (FDRA), to differentiate this DCI 418 from a message 3 UL grant. Moreover, the base station may configure one or more other fields or parameters 457b in the DCI 418, such as the Modulation and Coding Scheme (MCS), to indicate the power 406 or the repetition factor 408 or both for the SSB 402 or SIB-1 404. While the aforementioned examples specifically refer to four-step random access including RACH preamble 416 (message 1), a RAR (message 2), an UL grant (message 3), and a contention resolution (message 4) in separate messages, it should be understood that these examples may similarly apply to two-step random access in which the RACH preamble 416 and UL grant are combined in one message (msg A) and in which the RAR and contention resolution are combined in another message (msg B).

In some examples, the UE 104 may send implicit or explicit indications for requesting power 406 or power back-off, repetition factor 408, or other transmission parameter 410 for on-demand SSB 402 or SIB-1 404 transmissions using uplink signal 405. In one example, the UE may be configured to implicitly indicate the on-demand SSB 402 or SIB-1 404 power 406 or the repetition factor 408 according to the UL-WUS occasion or transmission occasion 458 carrying the request or uplink signal 405, where each occasion 458 is configured to correspond to a specific request such as a specific transmission power 406 or repetition factor 408. For instance, one RACH occasion or other UL occasion 458 may be associated with one transmission power 406 or repetition factor 408, another RACH occasion or other UL occasion 458 may be associated with another transmission power 406 or repetition factor 408, and the like. In another example where the UL-WUS such as uplink signal 405 is a RACH preamble 416 transmission, the UE may be configured to implicitly indicate the on-demand SSB 402 or SIB-1 404 power 406 or the repetition factor 408 according to a preamble group 460 including the RACH preamble 416 indicated in the request, where each preamble group 460 is configured to implicitly indicate a different SSB or SIB-1 power 406 or repetition factor 408. For instance, one preamble group 460 may be associated with one transmission power 406 or repetition factor 408, another preamble group 460 may be associated with another transmission power 406 or repetition factor 408, and the like. In a further example where the UL-WUS such as uplink signal 405 is a UCI 456 transmission, the UE may be configured to explicitly indicate the on-demand SSB or SIB-1 power 406 or the repetition factor 408 explicitly using UCI 456, where the payload of the UCI 456 itself includes the requested SSB 402 or SIB-1 404 power 406 or repetition factor 408.

In the aforementioned examples, references to specific configured values of SSB 402 or SIB-1 404 transmission powers 406, such as {0, −3 dB, −4 dB, −6 dB}, or specific configured numbers of possible repetition factors 408 of beams 426, 428, such as {1, 2, 4, 8}, should be understood to be non-limiting and that different transmission power 406 values or repetition factors 408 may be configured in other examples. Moreover, it should be understood that references to transmission power 406 throughout this disclosure may encompass not only power levels or values the base station 102 is to apply to its SSB 402 or SIB-1 404 transmissions, but also power backoffs with which the base station may adjust its SSB 402 or SIB-1 404 transmissions. Furthermore, while the various examples described throughout the disclosure refer specifically to transmission power 406 or repetition factors 408, it should be understood that these examples may similarly apply to other transmission parameters 410 of on-demand SSBs 402 or SIB-1s 404. Additionally, these and other described examples throughout the disclosure may apply to carrier aggregation scenarios, for example, where the UE may receive a DCI 433, RRC configuration, or other information on a primary carrier indicating the transmission parameter 410 of an SSB 402 or SIB-1 404 on a secondary carrier, or on a secondary carrier indicating the transmission parameter of an SSB or SIB-1 on another secondary carrier.

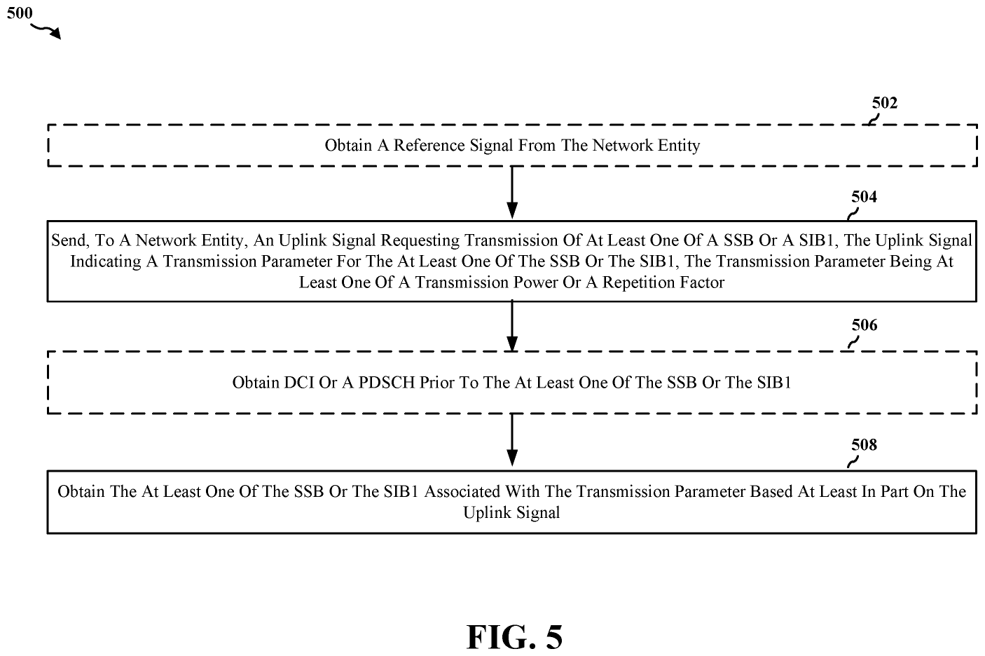

FIG. 5 is a flowchart 500 of a method of wireless communication. The method may be performed by a UE or one or more of its components, for example, the UE 104, 350; one or more of RX processor(s) 356, TX processor(s) 368, or controller(s)/processor(s) 359; the apparatus 702; or cellular baseband processor(s) 704 or its components. Optional aspects are illustrated in dashed lines. The method allows a UE to dynamically request and obtain a SSB or a SIB1 from a network entity with optimized transmission parameters, such as transmission power or repetition factor, based on the UE's requirements and network conditions, resulting in improved energy efficiency and network performance.

At block 502, the UE may obtain a reference signal from a network entity such as a base station. For example, 502 may be performed by downlink signal component 740. Obtaining the reference signal may include, for example, receiving, demodulating, and decoding an encoded and modulated signal including the reference signal using one or more of RX processor(s) 356 or controller(s)/processor(s) 359 such as described with respect to UE 350 in FIG. 3. For instance, referring to FIG. 4, the UE 104, 350 may receive reference signal 424 from base station 102, 310, such as a DRS.

At block 504, the UE sends to a network entity, an uplink signal requesting transmission of at least one of a SSB or a SIB1, the uplink signal indicating a transmission parameter for the at least one of the SSB or the SIB1, the transmission parameter being at least one of a transmission power or a repetition factor. For example, 504 may be performed by uplink signal component 742. Sending the uplink signal may include, for example, transmitting, modulating, and encoding the uplink signal using one or more of the TX processor(s) 368 or controller(s)/processor(s) 359, such as described with respect to UE 350 in FIG. 3. For instance, as described with respect to FIG. 4, the UE 104, 350 may transmit uplink signal 405 to base station 102, 310 requesting on-demand transmission of SSB 402 or SIB-1 404 or both. The uplink signal 405 may implicitly or explicitly indicate transmission parameter(s) 410, such as transmission power 406 or repetition factor 408 or a combination of these parameters, for SSB 402 or SIB-1 404 or both.

At block 506, the UE may obtain a DCI or a PDSCH prior to the at least one of the SSB or the SIB1. For example, 506 may be performed by downlink signal component 740. Obtaining the DCI or PDSCH may include, for example, receiving, demodulating, and decoding an encoded and modulated signal including the DCI or PDSCH using one or more of RX processor(s) 356 or controller(s)/processor(s) 359 such as described with respect to UE 350 in FIG. 3. For instance, referring to FIG. 4, the UE 104, 350 may receive DCI 433 or PDSCH 434 from base station 102, 310 prior to receiving SSB 402 or SIB-1 404.

Finally, at block 508, the UE obtains the at least one of the SSB or the SIB1 associated with the transmission parameter based at least in part on the uplink signal. For example, 508 may be performed by on-demand signal component 744. Obtaining the at least one of the SSB or the SIB1 may include, for example, receiving, demodulating, and decoding an encoded and modulated signal including the SSB or the SIB1 using one or more of RX processor(s) 356 or controller(s)/processor(s) 359 such as described with respect to UE 350 in FIG. 3. For instance, referring to FIG. 4, the UE 104, 350 may receive SSB 402 or SIB-1 404 or both according to the requested, transmission parameter 410 indicated in uplink signal 405, or according to a different transmission parameter requested by another UE 449 or based on network decision. For example, the SSB or the SIB-1 may be received with an applied transmission power or repetition factor indicated in the uplink signal 405.

In one example, the transmission power is based on a measured RSRP of the reference signal obtained at block 502. For instance, referring to FIG. 4, the transmission power 406 indicated in the uplink signal 405 may be based on RSRP 422 of reference signal 424.

In one example, the uplink signal indicates the transmission power respectively for one or a subset of SSB transmission beams, or one or a subset of SIB1 transmission beams, requested in the uplink signal or transmitted from the network entity. For instance, referring to FIG. 4, uplink signal 405 from UE 104 may indicate transmission power 406 for one or multiple transmission beams 426, 428 requested from base station 102 in uplink signal 405 or transmitted from base station 102 in response to uplink signal 405 and carrying SSB 402 or SIB-1 404.

In one example, the uplink signal indicates the transmission power from a preconfigured set of transmission power values for SSBs or SIBis. For instance, referring to FIG. 4, uplink signal 405 from UE 104 may indicate transmission power 406 from pre-defined set of values 430 for SSB 402 or SIB-1 404.

In one example, the at least one of the SSB or the SIB1 includes a channel indicating the transmission power based on the uplink signal or indicating a different transmission power based on another uplink signal from a different UE. For instance, referring to FIG. 4, channel 432 of SSB 402 (PBCH) or channel 432 of SIB-1 404 (PDSCH) may indicate the transmission power 406 requested in uplink signal 405 from UE 104, or the transmission power 406 requested in uplink signal 405 from another UE 449.

In one example, the uplink signal indicates the repetition factor from a preconfigured set of repetition factors for SSBs or SIB1s. For instance, referring to FIG. 4, uplink signal 405 from UE 104 may indicate repetition factor 408 of SSB 402 or SIB-1 404 from predefined set of possible factors 438 for repetitions 436.

In one example, the uplink signal further indicates a request basis for SSB repetitions or SIB1 repetitions, the request basis being reception beam combining or reception beam refinement, and a number of repetitions of the at least one of the SSB or the SIB1 is a function of the request basis. For instance, referring to FIG. 4, uplink signal 405 may indicate the basis 439 of UE 104 for repetitions 436 of SSB 402 or SIB-1 404, including Rx combining 412 or Rx beam refinement 414, and a number of the repetitions 436 applied for SSB 402 or SIB-1 404 may be different depending on the basis 439 indicated.

In one example, the at least one of the SSB or the SIB1 is obtained in repetitions in at least one of a time domain or a frequency domain based on a frequency range associated with the SSB or the SIB1. For instance, referring to FIG. 4, UE 104 may receive SSB 402 or SIB-1 404 in repetitions 436 within time domain 440 or frequency domain 442 depending on the frequency range 444 in which SSB 402 or SIB-1 404 is received.

In one example, the uplink signal indicates the repetition factor respectively for one or more SSB transmission beams or one or more SIB transmission beams, and the at least one of SSB or the SIB1 is obtained in consecutive repetition occasions or inconsecutive repetition occasions for the one or more SSB transmission beams or the one or more SIB transmission beams. For instance, referring to FIG. 4, after UE 104 transmits uplink signal 405 indicating repetition factor(s) 408 of SSB 402 or SIB-1 404 transmitted in one or more beams 426, 428, base station 102 may transmit the SSB 402 or SIB-1 404 in the beams 426, 428 using sequential or consecutive repetitions 446 or inconsecutive repetitions 448 in corresponding occasions for the beams 426, 428 such as illustrated in FIG. 4.

In one example, the at least one of the SSB or the SIB1 is obtained in repetitions according to a maximum configured repetition factor associated with multiple UEs. For instance, referring to FIG. 4, UEs 104, 449 may receive SSB 402 or SIB-1 404 in repetitions 436 given by maximum configured repetition factor 450.

In one example, the at least one of the SSB or the SIB1 is obtained in repetitions according to a maximum requested repetition factor from between multiple UEs, the at least one of the SSB or the SIB1 including a channel indicating the maximum requested repetition factor, and the at least one of the SSB or the SIB1 being obtained in the repetitions at a periodicity for decoding the channel. For instance, referring to FIG. 4, UEs 104, 449 may receive SSB 402 or SIB-1 404 in repetitions 436 given by maximum number of requested repetitions 452, where the SSB 402 or SIB-1 404 indicate in its respective channel 432 the maximum number of requested repetitions 452 being applied, and where the periodicity 454 of repetitions 436 of SSB 402 or SIB-1 404 is of a sufficient size for UEs 104, 449 to successfully decode SSB 402 or SIB-1 404 between repetition occasions.

In one example, the DCI or the PDSCH obtained at block 506 indicates a maximum requested repetition factor for the at least one of the SSB or the SIB1 from between multiple UEs or indicates the transmission power for the at least one of the SSB or the SIB1. For instance, referring to FIG. 4, DCI 433 or PDSCH 434 may indicate the maximum number of requested repetitions 452 as the repetition factor 408 applied to SSB 402 or SIB-1 404 for UEs 104, 449. Alternatively or additionally, the DCI 433 or PDSCH 434 may indicate the transmission power 406 applied to the SSB 402 or SIB-1 404.

In one example of obtaining DCI at block 506 in the case where the uplink signal includes a RACH preamble, the UE may obtain, in response to the uplink signal, DCI in a RAR window associated with the RACH preamble, the DCI indicating subsequent transmission of the at least one of the SSB or the SIB1 via a first parameter in the DCI and indicating the transmission power or the repetition factor via a second parameter in the DCI. For instance, referring to FIG. 4, when UE 104 includes RACH preamble 416 in uplink signal 405, UE 104 may receive DCI 418 including parameters 457 within the RAR window 420 corresponding to the RACH preamble 416 in response to uplink signal 405. DCI 418 may indicate via parameter 457a that transmission of SSB 402 or SIB-1 404 will follow instead of a message 3 or message B PUSCH transmission. DCI 418 may also indicate via parameter 457b the transmission power 406 or repetition factor 408 applied to the SSB 402 or SIB-1 404.

In one example, the uplink signal is sent in a transmission occasion or includes a RACH preamble from a preamble group, and the transmission power or the repetition factor is indicated via the transmission occasion or the preamble group. For instance, referring to FIG. 4, the UL occasion 458 in which UE 104 transmits uplink signal 405 may indicate the transmission power 406 or repetition factor 408 requested for SSB 402 or SIB-1 404. Alternatively or additionally, the preamble group 460 from which UE 104 may select the RACH preamble 416 included in uplink signal 405 may indicate the transmission power 406 or repetition factor 408 requested for SSB 402 or SIB-1 404. Thus, UE 104 may implicitly indicate its power or repetition factor recommendation using uplink signal 405.

In one example, the uplink signal includes UCI, the UCI indicating the transmission power or the repetition factor for the at least one of the SSB or the SIB1. For instance, referring to FIG. 4, the uplink signal 405 may include UCI 456 which indicates the transmission power 406 or repetition factor 408 requested for SSB 402 or SIB-1 404. Thus, UE 104 may explicitly indicate its power or repetition factor recommendation using uplink signal 405.

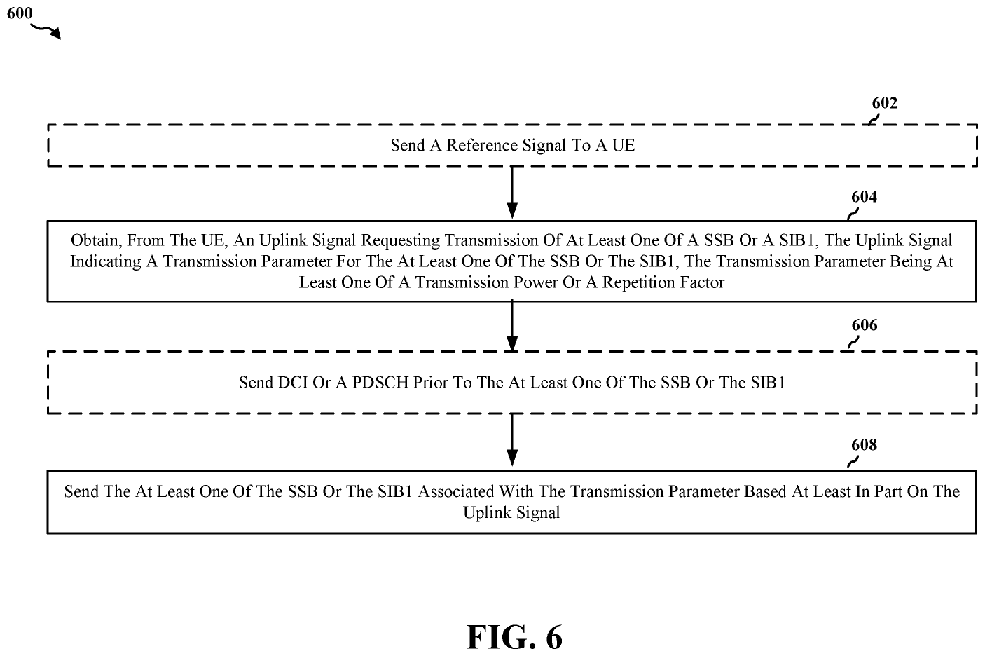

FIG. 6 is a flowchart 600 of a method of wireless communication. The method may be performed by a network entity such as a base station or one or more of its components, for example, the base station 102/180, 310; disaggregated base station 181 or one or more of its components; one or more of RX processor(s) 370, TX processor(s) 316, or controller(s)/processor(s) 375; the apparatus 802; or baseband unit(s) 804 or its components. Optional aspects are illustrated in dashed lines. The method allows a network entity to dynamically respond to uplink signals from UEs requesting transmission of a SSB or an SIB1 with optimized transmission parameters, such as transmission power or repetition factor, based on the UEs' requirements and network conditions, resulting in improved energy efficiency and network performance.

At block 602, the network entity sends a reference signal to a UE. For example, 1202 may be performed by downlink signal component 840. Sending the reference signal may include, for example, transmitting, modulating, and encoding the reference signal using one or more of the TX processor(s) 316 or controller(s)/processor(s) 375, such as described with respect to BS 310 in FIG. 3. For instance, referring to FIG. 4, the base station 102, 310 may transmit reference signal 424 to UE 104, 350, such as a DRS.

At block 604, the network entity obtains from the UE, an uplink signal requesting transmission of at least one of a SSB or a SIB1, the uplink signal indicating a transmission parameter for the at least one of the SSB or the SIB1, the transmission parameter being at least one of a transmission power or a repetition factor. For example, 604 may be performed by uplink signal component 842. Obtaining the uplink signal may include, for example, receiving, demodulating, and decoding an encoded and modulated signal including the uplink signal using one or more of RX processor(s) 370 or controller(s)/processor(s) 375 such as described with respect to BS 310 in FIG. 3. For instance, as described with respect to FIG. 4, the base station 102 may receive uplink signal 405 from UE 104, 350 requesting on-demand transmission of SSB 402 or SIB-1 404 or both. The uplink signal 405 may implicitly or explicitly indicate transmission parameter(s) 410, such as transmission power 406 or repetition factor 408 or a combination of these parameters, for SSB 402 or SIB-1 404 or both.

At block 606, the network entity may send a DCI or a PDSCH prior to the at least one of the SSB or the SIB1. For example, 606 may be performed by downlink signal component 840. Sending the DCI or PDSCH may include, for example, transmitting, modulating, and encoding the DCI or PDSCH using one or more of the TX processor(s) 316 or controller(s)/processor(s) 375, such as described with respect to BS 310 in FIG. 3. For instance, referring to FIG. 4, the base station 102, 310 may transmit DCI 433 or PDSCH 434 to UE 104, 350 prior to transmitting SSB 402 or SIB-1 404 or both.

Finally, at block 608, the network entity sends the at least one of the SSB or the SIB1 associated with the transmission parameter based at least in part on the uplink signal. For example, 608 may be performed by on-demand signal component 844. Sending the at least one of the SSB or the SIB1 may include, for example, transmitting, modulating, and encoding the at least one of the SSB or SIB1 using one or more of the TX processor(s) 316 or controller(s)/processor(s) 375, such as described with respect to BS 310 in FIG. 3. For instance, referring to FIG. 4, the base station 102, 310 may transmit SSB 402 or SIB-1 404 or both according to the requested, transmission parameter 410 indicated in uplink signal 405, or according to a different transmission parameter requested by another UE 449 or based on network decision. For example, the SSB or the SIB-1 may be transmitted with an applied transmission power or repetition factor indicated in the uplink signal 405.

In one example, the transmission power is based on a measured RSRP of the reference signal sent at block 602. For instance, referring to FIG. 4, the transmission power 406 indicated in the uplink signal 405 may be based on RSRP 422 of reference signal 424.

In one example, the uplink signal indicates the transmission power respectively for one or a subset of SSB transmission beams, or one or a subset of SIB1 transmission beams, requested in the uplink signal or transmitted from the network entity. For instance, referring to FIG. 4, uplink signal 405 from UE 104 may indicate transmission power 406 for one or multiple transmission beams 426, 428 requested from base station 102 in uplink signal 405 or transmitted from base station 102 in response to uplink signal 405 and carrying SSB 402 or SIB-1 404.

In one example, the uplink signal indicates the transmission power from a preconfigured set of transmission power values for SSBs or SIBis. For instance, referring to FIG. 4, uplink signal 405 from UE 104 may indicate transmission power 406 from pre-defined set of values 430 for SSB 402 or SIB-1 404.

In one example, the at least one of the SSB or the SIB1 includes a channel indicating the transmission power based on the uplink signal or indicating a different transmission power based on another uplink signal from a different UE. For instance, referring to FIG. 4, channel 432 of SSB 402 (PBCH) or channel 432 of SIB-1 404 (PDSCH) may indicate the transmission power 406 requested in uplink signal 405 from UE 104, or the transmission power 406 requested in uplink signal 405 from another UE 449.

In one example, the uplink signal indicates the repetition factor from a preconfigured set of repetition factors for SSBs or SIB1s. For instance, referring to FIG. 4, uplink signal 405 from UE 104 may indicate repetition factor 408 of SSB 402 or SIB-1 404 from predefined set of possible factors 438 for repetitions 436.

In one example, the uplink signal further indicates a request basis for SSB repetitions or SIB1 repetitions, the request basis being reception beam combining or reception beam refinement, and a number of repetitions of the at least one of the SSB or the SIB1 is a function of the request basis. For instance, referring to FIG. 4, uplink signal 405 may indicate the basis 439 of UE 104 for repetitions 436 of SSB 402 or SIB-1 404, including Rx combining 412 or Rx beam refinement 414, and a number of the repetitions 436 applied for SSB 402 or SIB-1 404 may be different depending on the basis 439 indicated.

In one example, the at least one of the SSB or the SIB1 is sent in repetitions in at least one of a time domain or a frequency domain based on a frequency range associated with the SSB or the SIB1. For instance, referring to FIG. 4, base station 102 may transmit SSB 402 or SIB-1 404 in repetitions 436 within time domain 440 or frequency domain 442 depending on the frequency range 444 in which SSB 402 or SIB-1 404 is transmitted.

In one example, the uplink signal indicates the repetition factor respectively for one or more SSB transmission beams or one or more SIB transmission beams, and the at least one of the SSB or the SIB1 is sent in consecutive repetition occasions or inconsecutive repetition occasions for the one or more SSB transmission beams or the one or more SIB transmission beams. For instance, referring to FIG. 4, after base station 102 receives uplink signal 405 indicating repetition factor(s) 408 of SSB 402 or SIB-1 404 transmitted in one or more beams 426, 428, base station 102 may transmit and UE 104 may receive the SSB 402 or SIB-1 404 in the beams 426, 428 using sequential or consecutive repetitions 446 or inconsecutive repetitions 448 in corresponding occasions for the beams 426, 428 such as illustrated in FIG. 4.

In one example, the at least one of the SSB or the SIB1 is sent in repetitions according to a maximum configured repetition factor associated with multiple UEs. For instance, referring to FIG. 4, base station 102 may transmit and UEs 104, 449 may receive SSB 402 or SIB-1 404 in repetitions 436 given by maximum configured repetition factor 450.

In one example, the at least one of the SSB or the SIB1 is sent in repetitions according to a maximum requested repetition factor from between multiple UEs, the at least one of the SSB or the SIB1 including a channel indicating the maximum requested repetition factor, and the at least one of the SSB or the SIB1 being sent in the repetitions at a periodicity for decoding the channel. For instance, referring to FIG. 4, base station 102 may transmit and UEs 104, 449 may receive SSB 402 or SIB-1 404 in repetitions 436 given by maximum number of requested repetitions 452, where the SSB 402 or SIB-1 404 indicate in its respective channel 432 the maximum number of requested repetitions 452 being applied, and where the periodicity 454 of repetitions 436 of SSB 402 or SIB-1 404 is of a sufficient size for UEs 104, 449 to successfully decode SSB 402 or SIB-1 404 between repetition occasions.

In one example, the DCI or the PDSCH sent at block 606 indicates a maximum requested repetition factor for the at least one of the SSB or the SIB1 from between multiple UEs or indicates the transmission power for the at least one of the SSB or the SIB1. For instance, referring to FIG. 4, DCI 433 or PDSCH 434 may indicate the maximum number of requested repetitions 452 as the repetition factor 408 applied to SSB 402 or SIB-1 404 for UEs 104, 449. Alternatively or additionally, the DCI 433 or PDSCH 434 may indicate the transmission power 406 applied to the SSB 402 or SIB-1 404.

In one example of sending DCI at block 606 in the case where the uplink signal includes a RACH preamble, the network entity may send, in response to the uplink signal, DCI in a RAR window associated with the RACH preamble, the DCI indicating subsequent transmission of the at least one of the SSB or the SIB1 via a first parameter in the DCI and indicating the transmission power or the repetition factor via a second parameter in the DCI. For instance, referring to FIG. 4, when UE 104 includes RACH preamble 416 in uplink signal 405, base station 102 may transmit and UE 104 may receive DCI 418 including parameters 457 within the RAR window 420 corresponding to the RACH preamble 416 in response to uplink signal 405. DCI 418 may indicate via parameter 457a that transmission of SSB 402 or SIB-1 404 will follow instead of a message 3 or message B PUSCH transmission. DCI 418 may also indicate via parameter 457b the transmission power 406 or repetition factor 408 applied to the SSB 402 or SIB-1 404.

In one example, the uplink signal is obtained in a transmission occasion or includes a RACH preamble from a preamble group, and the transmission power or the repetition factor is indicated via the transmission occasion or the preamble group. For instance, referring to FIG. 4, the UL occasion 458 in which UE 104 transmits and base station 102 receives uplink signal 405 may indicate the transmission power 406 or repetition factor 408 requested for SSB 402 or SIB-1 404. Alternatively or additionally, the preamble group 460 from which UE 104 may select the RACH preamble 416 included in uplink signal 405 may indicate the transmission power 406 or repetition factor 408 requested for SSB 402 or SIB-1 404. Thus, UE 104 may implicitly indicate its power or repetition factor recommendation using uplink signal 405.

In one example, the uplink signal includes UCI, the UCI indicating the transmission power or the repetition factor for the at least one of the SSB or the SIB1. For instance, referring to FIG. 4, the uplink signal 405 may include UCI 456 which indicates the transmission power 406 or repetition factor 408 requested for SSB 402 or SIB-1 404. Thus, UE 104 may explicitly indicate its power or repetition factor recommendation using uplink signal 405.

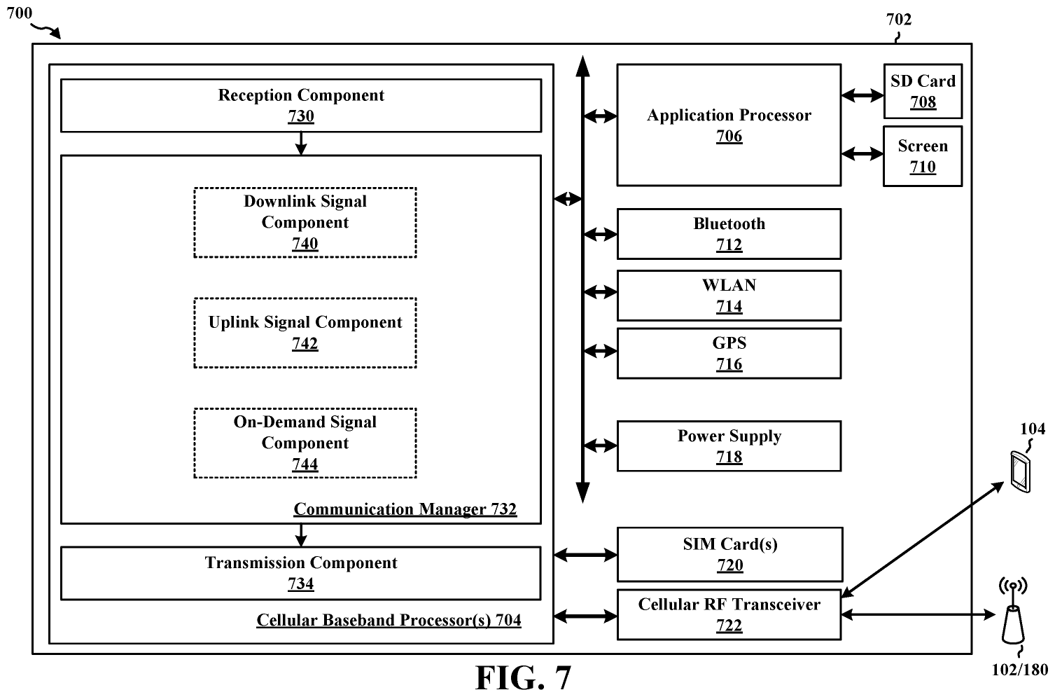

FIG. 7 is a diagram 700 illustrating an example of a hardware implementation for an apparatus 702. The apparatus 702 is a UE and includes one or more cellular baseband processors 704 (also referred to as a modem) coupled to a cellular RF transceiver 722 and one or more subscriber identity modules (SIM) cards 720, an application processor 706 coupled to a secure digital (SD) card 708 and a screen 710, a Bluetooth module 712, a wireless local area network (WLAN) module 714, a Global Positioning System (GPS) module 716, and a power supply 718. The one or more cellular baseband processors 704 communicate through the cellular RF transceiver 722 with the UE 104 and/or BS 102/180/disaggregated base station 181. The one or more cellular baseband processors 704 may each include a computer-readable medium/one or more memories. The computer-readable medium/one or more memories may be non-transitory. The one or more cellular baseband processors 704 are responsible for general processing, including the execution of software stored on the computer-readable medium/one or more memories individually or in combination. The software, when executed by the one or more cellular baseband processors 704, causes the one or more cellular baseband processors 704 to, individually or in combination, perform the various functions described supra. The computer-readable medium/one or more memories may also be used individually or in combination for storing data that is manipulated by the one or more cellular baseband processors 704 when executing software. The one or more cellular baseband processors 704 individually or in combination further include a reception component 730, a communication manager 732, and a transmission component 734. The communication manager 732 includes the one or more illustrated components. The components within the communication manager 732 may be stored in the computer-readable medium/one or more memories and/or configured as hardware within the one or more cellular baseband processors 704. The one or more cellular baseband processors 704 may be components of the UE 350 and may individually or in combination include the one or more memories 360 and/or at least one of the one or more TX processors 368, at least one of the one or more RX processors 356, and at least one of the one or more controllers/processors 359. For example, the reception component 730 may include at least the one or more RX processors 356, the transmission component 734 may include at least the one or more TX processors 368, and the communication manager 732 may include at least the one or more controllers/processors 359. In one configuration, the apparatus 702 may be a modem chip and include just the one or more baseband processors 704, and in another configuration, the apparatus 702 may be the entire UE (e.g., see 350 of FIG. 3) and include the aforediscussed additional modules of the apparatus 702.

The communication manager 732 includes a downlink signal component 740 that is configured to obtain, for example via reception component 730, a reference signal from a network entity, such as described in connection with block 502. The downlink signal component 740 may alternatively or additionally be configured to obtain, for example via reception component 730, DCI or a PDSCH prior to the at least one of the SSB or the SIB1, such as described in connection with block 506. The communication manager 732 may further include an uplink signal component 744 that is configured to send to a network entity, for example via transmission component 734, an uplink signal requesting transmission of at least one of a SSB or a SIB1, the uplink signal indicating a transmission parameter for the at least one of the SSB or the SIB1, the transmission parameter being at least one of a transmission power or a repetition factor, such as described in connection with block 504. The communication manager 732 may further include an on-demand signal component 744 that is configured to obtain the at least one of the SSB or the SIB1 associated with the transmission parameter based at least in part on the uplink signal, such as described in connection with block 508.

The apparatus may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 702, and in particular one or more cellular baseband processors 704, includes means for sending, to a network entity, an uplink signal requesting transmission of at least one of a SSB or a SIB1, the uplink signal indicating a transmission parameter for the at least one of the SSB or the SIB1, the transmission parameter being at least one of a transmission power or a repetition factor; and means for obtaining the at least one of the SSB or the SIB1 associated with the transmission parameter based at least in part on the uplink signal.

The aforementioned means may be one or more of the aforementioned components of the apparatus 702 configured to perform the functions recited by the aforementioned means. As described supra, the apparatus 702 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

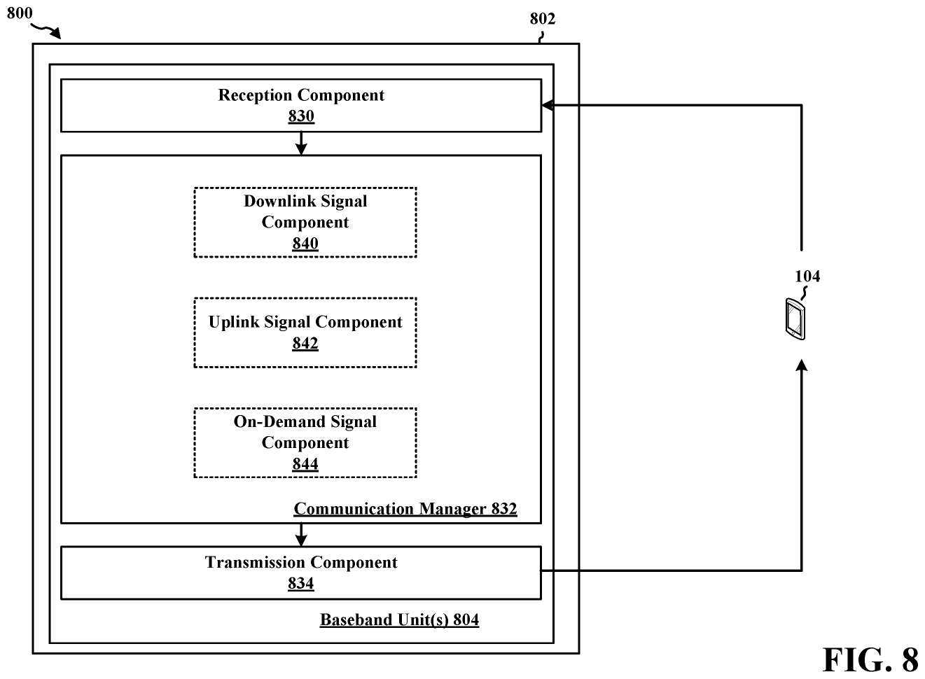

FIG. 8 is a diagram 800 illustrating an example of a hardware implementation for an apparatus 802. The apparatus 802 is a network entity such as a base station and includes one or more baseband units 804. The one or more baseband units 804 communicate through a cellular RF transceiver with the UE 104. The one or more baseband units 804 may each include a computer-readable medium/one or more memories. The computer-readable medium/one or more memories may be non-transitory. The one or more baseband units 804 are responsible for general processing, including the execution of software stored on the computer-readable medium/one or more memories individually or in combination. The software, when executed by the one or more baseband units 804, causes the one or more baseband units 804 to, individually or in combination, perform the various functions described supra. The computer-readable medium/one or more memories may also be used individually or in combination for storing data that is manipulated by the one or more baseband units 804 when executing software. The one or more baseband units 804 individually or in combination further include a reception component 830, a communication manager 832, and a transmission component 834. The communication manager 832 includes the one or more illustrated components. The components within the communication manager 832 may be stored in the computer-readable medium/one or more memories and/or configured as hardware within the one or more baseband units 804. The one or more baseband units 804 may be components of the BS 310 and may individually or in combination include the one or more memories 376 and/or at least one of the one or more TX processors 316, at least one of the one or more RX processors 370, and at least one of the one or more controllers/processors 375. For example, the reception component 830 may include at least the one or more RX processors 370, the transmission component 834 may include at least the one or more TX processors 316, and the communication manager 832 may include at least the one or more controllers/processors 375.

The communication manager 832 includes a downlink signal component 840 that is configured to send, for example via transmission component 834, a reference signal to a UE, such as described in connection with block 602. The downlink signal component 840 may alternatively or additionally be configured to send, for example via transmission component 834, DCI or a PDSCH prior to the at least one of the SSB or the SIB1, such as described in connection with block 606. The communication manager 832 may further include an uplink signal component 844 that is configured to obtain from a UE, for example via reception component 830, an uplink signal requesting transmission of at least one of a SSB or a SIB1, the uplink signal indicating a transmission parameter for the at least one of the SSB or the SIB1, the transmission parameter being at least one of a transmission power or a repetition factor, such as described in connection with block 604. The communication manager 832 may further include an on-demand signal component 844 that is configured to send the at least one of the SSB or the SIB1 associated with the transmission parameter based at least in part on the uplink signal, such as described in connection with block 608.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 802, and in particular one or more baseband units 804, includes means for obtaining, from a UE, an uplink signal requesting transmission of at least one of a SSB or a SIB1, the uplink signal indicating a transmission parameter for the at least one of the SSB or the SIB1, the transmission parameter being at least one of a transmission power or a repetition factor; and means for sending the at least one of the SSB or the SIB1 associated with the transmission parameter based at least in part on the uplink signal.

The aforementioned means may be one or more of the aforementioned components of the apparatus 802 configured to perform the functions recited by the aforementioned means. As described supra, the apparatus 802 may include the one or more TX Processors 316, the one or more RX Processors 370, and the one or more controllers/processors 375. As such, in one configuration, the aforementioned means may be at least one of the one or more TX Processors 316, at least one of the one or more RX Processors 370, or at least one of the one or more controllers/processors 375, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: send, to a network entity, an uplink signal requesting transmission of at least one of a synchronization signal block (SSB) or a system information block type 1 (SIB1), the uplink signal indicating a transmission parameter for the at least one of the SSB or the SIB1, the transmission parameter being at least one of a transmission power or a repetition factor; and obtain the at least one of the SSB or the SIB1 associated with the transmission parameter based at least in part on the uplink signal.

Clause 2. The apparatus of clause 1, wherein the one or more processors, individually or in any combination, are operable to cause the apparatus to: obtain a reference signal from the network entity, the transmission power being based on a measured reference signal received power (RSRP) of the reference signal.

Clause 3. The apparatus of clause 1 or clause 2, wherein the uplink signal indicates the transmission power respectively for one or a subset of SSB transmission beams, or one or a subset of SIB1 transmission beams, requested in the uplink signal or transmitted from the network entity.

Clause 4. The apparatus of any of clauses 1 to 3, wherein the uplink signal indicates the transmission power from a preconfigured set of transmission power values for SSBs or SIB1s.

Clause 5. The apparatus of any of clauses 1 to 4, wherein the at least one of the SSB or the SIB1 includes a channel indicating the transmission power based on the uplink signal or indicating a different transmission power based on another uplink signal from a different user equipment (UE).

Clause 6. The apparatus of any of clauses 1 to 5, wherein the uplink signal indicates the repetition factor from a preconfigured set of repetition factors for SSBs or SIB1s.

Clause 7. The apparatus of any of clauses 1 to 6, wherein the uplink signal further indicates a request basis for SSB repetitions or SIB1 repetitions, the request basis being reception beam combining or reception beam refinement, and a number of repetitions of the at least one of the SSB or the SIB1 is a function of the request basis.

Clause 8. The apparatus of any of clauses 1 to 7, wherein the at least one of the SSB or the SIB1 is obtained in repetitions in at least one of a time domain or a frequency domain based on a frequency range associated with the at least one of the SSB or the SIB1.

Clause 9. The apparatus of any of clauses 1 to 8, wherein the uplink signal indicates the repetition factor respectively for one or more SSB transmission beams or one or more SIB transmission beams, and the at least one of the SSB or the SIB1 is obtained in consecutive repetition occasions or inconsecutive repetition occasions for the one or more SSB transmission beams or the one or more SIB transmission beams.

Clause 10. The apparatus of any of clauses 1 to 9, wherein the at least one of the SSB or the SIB1 is obtained in repetitions according to a maximum configured repetition factor associated with multiple user equipment (UEs).

Clause 11. The apparatus of any of clauses 1 to 9, wherein the at least one of the SSB or the SIB1 is obtained in repetitions according to a maximum requested repetition factor from between multiple user equipment (UEs), the at least one of the SSB or the SIB1 including a channel indicating the maximum requested repetition factor, and the at least one of the SSB or the SIB1 being obtained in the repetitions at a periodicity for decoding the channel.

Clause 12. The apparatus of any of clauses 1 to 11, wherein the one or more processors, individually or in any combination, are operable to cause the apparatus to: obtain downlink control information (DCI) or a physical downlink shared channel (PDSCH) prior to the at least one of the SSB or the SIB1, the DCI or the PDSCH indicating a maximum requested repetition factor for the at least one of the SSB or the SIB1 from between multiple user equipment (UEs) or indicating the transmission power for the at least one of the SSB or the SIB1.

Clause 13. The apparatus of any of clauses 1 to 12, wherein the uplink signal includes a random access channel (RACH) preamble, and the one or more processors, individually or in any combination, are operable to cause the apparatus to: obtain, in response to the uplink signal, downlink control information (DCI) in a random access response (RAR) window associated with the RACH preamble, the DCI indicating subsequent transmission of the at least one of the SSB or the SIB1 via a first parameter in the DCI and indicating the transmission power or the repetition factor via a second parameter in the DCI.

Clause 14. The apparatus of any of clauses 1 to 13, wherein the uplink signal is sent in a transmission occasion or includes a random access channel (RACH) preamble from a preamble group, and the transmission power or the repetition factor is indicated via the transmission occasion or the preamble group.

Clause 15. The apparatus of any of clauses 1 to 13, wherein the uplink signal includes uplink control information (UCI), the UCI indicating the transmission power or the repetition factor for the at least one of the SSB or the SIB1.

Clause 16. An apparatus for wireless communication, comprising: one or more memories; and one or more processors each communicatively coupled with at least one of the one or more memories, the one or more processors, individually or in any combination, operable to cause the apparatus to: obtain, from a user equipment (UE), an uplink signal requesting transmission of at least one of a synchronization signal block (SSB) or a system information block type 1 (SIB1), the uplink signal indicating a transmission parameter for the at least one of the SSB or the SIB1, the transmission parameter being at least one of a transmission power or a repetition factor; and send the at least one of the SSB or the SIB1 associated with the transmission parameter based at least in part on the uplink signal.

Clause 17. The apparatus of clause 16, wherein the one or more processors, individually or in any combination, are operable to cause the apparatus to: send a reference signal to the UE, the transmission power being based on a measured reference signal received power (RSRP) of the reference signal.

Clause 18. The apparatus of clause 16 or clause 17, wherein the uplink signal indicates the transmission power respectively for one or a subset of SSB transmission beams, or one or a subset of SIB1 transmission beams, requested in the uplink signal or transmitted from the apparatus.

Clause 19. The apparatus of any of clauses 16 to 18, wherein the uplink signal indicates the transmission power from a preconfigured set of transmission power values for SSBs or SIB1s.

Clause 20. The apparatus of any of clauses 16 to 19, wherein the at least one of the SSB or the SIB1 includes a channel indicating the transmission power based on the uplink signal or indicating a different transmission power based on another uplink signal from a different UE.

Clause 21. The apparatus of any of clauses 16 to 20, wherein the uplink signal indicates the repetition factor from a preconfigured set of repetition factors for SSBs or SIB1s.

Clause 22. The apparatus of any of clauses 16 to 21, wherein the uplink signal further indicates a request basis for SSB repetitions or SIB1 repetitions, the request basis being reception beam combining or reception beam refinement, and a number of repetitions of the at least one of the SSB or the SIB1 is a function of the request basis.

Clause 23. The apparatus of any of clauses 16 to 22, wherein the at least one of the SSB or the SIB1 is sent in repetitions in at least one of a time domain or a frequency domain based on a frequency range associated with the at least one of the SSB or the SIB1.

Clause 24. The apparatus of any of clauses 16 to 23, wherein the uplink signal indicates the repetition factor respectively for one or more SSB transmission beams or one or more SIB transmission beams, and the at least one of the SSB or the SIB1 is sent in consecutive repetition occasions or inconsecutive repetition occasions for the one or more SSB transmission beams or the one or more SIB transmission beams.

Clause 25. The apparatus of any of clauses 16 to 24, wherein the at least one of the SSB or the SIB1 is sent in repetitions according to a maximum requested repetition factor from between multiple UEs, the at least one of the SSB or the SIB1 including a channel indicating the maximum requested repetition factor, and the at least one of the SSB or the SIB1 being sent in the repetitions at a periodicity for decoding the channel.

Clause 26. The apparatus of any of clauses 16 to 25, wherein the one or more processors, individually or in any combination, are operable to cause the apparatus to: send downlink control information (DCI) or a physical downlink shared channel (PDSCH) prior to the at least one of the SSB or the SIB1, the DCI or the PDSCH indicating a maximum requested repetition factor for the at least one of the SSB or the SIB1 from between multiple UEs or indicating the transmission power for the at least one of the SSB or the SIB1.

Clause 27. The apparatus of any of clauses 16 to 26, wherein the uplink signal includes a random access channel (RACH) preamble, and the one or more processors, individually or in any combination, are operable to cause the apparatus to: send, in response to the uplink signal, downlink control information (DCI) in a random access response (RAR) window associated with the RACH preamble, the DCI indicating subsequent transmission of the at least one of the SSB or the SIB1 via a first parameter in the DCI and indicating the transmission power or the repetition factor via a second parameter in the DCI.

Clause 28. The apparatus of any of clauses 16 to 27, wherein the uplink signal is obtained in a transmission occasion or includes a random access channel (RACH) preamble from a preamble group, the transmission power or the repetition factor being indicated via the transmission occasion or the preamble group, or the uplink signal includes uplink control information (UCI), the UCI indicating the transmission power or the repetition factor for the at least one of the SSB or the SIB1.

Clause 29. A method of wireless communication performable at a user equipment (UE), comprising: sending, to a network entity, an uplink signal requesting transmission of at least one of a synchronization signal block (SSB) or a system information block type 1 (SIB1), the uplink signal indicating a transmission parameter for the at least one of the SSB or the SIB1, the transmission parameter being at least one of a transmission power or a repetition factor; and obtaining the at least one of the SSB or the SIB1 associated with the transmission parameter based at least in part on the uplink signal.

Clause 30. A method of wireless communication performable at a network entity, comprising: obtaining, from a user equipment (UE), an uplink signal requesting transmission of at least one of a synchronization signal block (SSB) or a system information block type 1 (SIB1), the uplink signal indicating a transmission parameter for the at least one of the SSB or the SIB1, the transmission parameter being at least one of a transmission power or a repetition factor; and sending the at least one of the SSB or the SIB1 associated with the transmission parameter based at least in part on the uplink signal.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
send, to a network entity, an uplink signal requesting transmission of at least one of a synchronization signal block (SSB) or a system information block type 1 (SIB1), the uplink signal indicating a transmission parameter for the at least one of the SSB or the SIB1, the transmission parameter being at least one of a transmission power or a repetition factor; and
obtain the at least one of the SSB or the SIB1 associated with the transmission parameter based at least in part on the uplink signal.

2. The apparatus of claim 1, wherein the one or more processors, individually or in any combination, are operable to cause the apparatus to:
obtain a reference signal from the network entity, the transmission power being based on a measured reference signal received power (RSRP) of the reference signal.

3. The apparatus of claim 1, wherein the uplink signal indicates the transmission power respectively for one or a subset of SSB transmission beams, or one or a subset of SIB1 transmission beams, requested in the uplink signal or transmitted from the network entity.

4. The apparatus of claim 1, wherein the uplink signal indicates the transmission power from a preconfigured set of transmission power values for SSBs or SIB1s.

5. The apparatus of claim 1, wherein the at least one of the SSB or the SIB1 includes a channel indicating the transmission power based on the uplink signal or indicating a different transmission power based on another uplink signal from a different user equipment (UE).

6. The apparatus of claim 1, wherein the uplink signal indicates the repetition factor from a preconfigured set of repetition factors for SSBs or SIB1s.

7. The apparatus of claim 1, wherein the uplink signal further indicates a request basis for SSB repetitions or SIB1 repetitions, the request basis being reception beam combining or reception beam refinement, and a number of repetitions of the at least one of the SSB or the SIB1 is a function of the request basis.

8. The apparatus of claim 1, wherein the at least one of the SSB or the SIB1 is obtained in repetitions in at least one of a time domain or a frequency domain based on a frequency range associated with the at least one of the SSB or the SIB1.

9. The apparatus of claim 1, wherein the uplink signal indicates the repetition factor respectively for one or more SSB transmission beams or one or more SIB transmission beams, and the at least one of the SSB or the SIB1 is obtained in consecutive repetition occasions or inconsecutive repetition occasions for the one or more SSB transmission beams or the one or more SIB transmission beams.

10. The apparatus of claim 1, wherein the at least one of the SSB or the SIB1 is obtained in repetitions according to a maximum configured repetition factor associated with multiple user equipment (UEs).

11. The apparatus of claim 1, wherein the at least one of the SSB or the SIB1 is obtained in repetitions according to a maximum requested repetition factor from between multiple user equipment (UEs), the at least one of the SSB or the SIB1 including a channel indicating the maximum requested repetition factor, and the at least one of the SSB or the SIB1 being obtained in the repetitions at a periodicity for decoding the channel.

12. The apparatus of claim 1, wherein the one or more processors, individually or in any combination, are operable to cause the apparatus to:
obtain downlink control information (DCI) or a physical downlink shared channel (PDSCH) prior to the at least one of the SSB or the SIB1, the DCI or the PDSCH indicating a maximum requested repetition factor for the at least one of the SSB or the SIB1 from between multiple user equipment (UEs) or indicating the transmission power for the at least one of the SSB or the SIB1.

13. The apparatus of claim 1, wherein the uplink signal includes a random access channel (RACH) preamble, and the one or more processors, individually or in any combination, are operable to cause the apparatus to:
obtain, in response to the uplink signal, downlink control information (DCI) in a random access response (RAR) window associated with the RACH preamble, the DCI indicating subsequent transmission of the at least one of the SSB or the SIB1 via a first parameter in the DCI and indicating the transmission power or the repetition factor via a second parameter in the DCI.

14. The apparatus of claim 1, wherein the uplink signal is sent in a transmission occasion or includes a random access channel (RACH) preamble from a preamble group, and the transmission power or the repetition factor is indicated via the transmission occasion or the preamble group.

15. The apparatus of claim 1, wherein the uplink signal includes uplink control information (UCI), the UCI indicating the transmission power or the repetition factor for the at least one of the SSB or the SIB1.

16. An apparatus for wireless communication, comprising:
one or more memories; and
one or more processors each communicatively coupled with at least one of the one or more memories, the one or more processors, individually or in any combination, operable to cause the apparatus to:
obtain, from a user equipment (UE), an uplink signal requesting transmission of at least one of a synchronization signal block (SSB) or a system information block type 1 (SIB1), the uplink signal indicating a transmission parameter for the at least one of the SSB or the SIB1, the transmission parameter being at least one of a transmission power or a repetition factor; and
send the at least one of the SSB or the SIB1 associated with the transmission parameter based at least in part on the uplink signal.

17. The apparatus of claim 16, wherein the one or more processors, individually or in any combination, are operable to cause the apparatus to:
send a reference signal to the UE, the transmission power being based on a measured reference signal received power (RSRP) of the reference signal.

18. The apparatus of claim 16, wherein the uplink signal indicates the transmission power respectively for one or a subset of SSB transmission beams, or one or a subset of SIB1 transmission beams, requested in the uplink signal or transmitted from the apparatus.

19. The apparatus of claim 16, wherein the uplink signal indicates the transmission power from a preconfigured set of transmission power values for SSBs or SIB1s.

20. The apparatus of claim 16, wherein the at least one of the SSB or the SIB1 includes a channel indicating the transmission power based on the uplink signal or indicating a different transmission power based on another uplink signal from a different UE.

21. The apparatus of claim 16, wherein the uplink signal indicates the repetition factor from a preconfigured set of repetition factors for SSBs or SIB1s.

22. The apparatus of claim 16, wherein the uplink signal further indicates a request basis for SSB repetitions or SIB1 repetitions, the request basis being reception beam combining or reception beam refinement, and a number of repetitions of the at least one of the SSB or the SIB1 is a function of the request basis.

23. The apparatus of claim 16, wherein the at least one of the SSB or the SIB1 is sent in repetitions in at least one of a time domain or a frequency domain based on a frequency range associated with the at least one of the SSB or the SIB1.

24. The apparatus of claim 16, wherein the uplink signal indicates the repetition factor respectively for one or more SSB transmission beams or one or more SIB transmission beams, and the at least one of the SSB or the SIB1 is sent in consecutive repetition occasions or inconsecutive repetition occasions for the one or more SSB transmission beams or the one or more SIB transmission beams.

25. The apparatus of claim 16, wherein the at least one of the SSB or the SIB1 is sent in repetitions according to a maximum requested repetition factor from between multiple UEs, the at least one of the SSB or the SIB1 including a channel indicating the maximum requested repetition factor, and the at least one of the SSB or the SIB1 being sent in the repetitions at a periodicity for decoding the channel.

26. The apparatus of claim 16, wherein the one or more processors, individually or in any combination, are operable to cause the apparatus to:
send downlink control information (DCI) or a physical downlink shared channel (PDSCH) prior to the at least one of the SSB or the SIB1, the DCI or the PDSCH indicating a maximum requested repetition factor for the at least one of the SSB or the SIB1 from between multiple UEs or indicating the transmission power for the at least one of the SSB or the SIB1.

27. The apparatus of claim 16, wherein the uplink signal includes a random access channel (RACH) preamble, and the one or more processors, individually or in any combination, are operable to cause the apparatus to:
send, in response to the uplink signal, downlink control information (DCI) in a random access response (RAR) window associated with the RACH preamble, the DCI indicating subsequent transmission of the at least one of the SSB or the SIB1 via a first parameter in the DCI and indicating the transmission power or the repetition factor via a second parameter in the DCI.

28. The apparatus of claim 16, wherein
the uplink signal is obtained in a transmission occasion or includes a random access channel (RACH) preamble from a preamble group, the transmission power or the repetition factor being indicated via the transmission occasion or the preamble group, or
the uplink signal includes uplink control information (UCI), the UCI indicating the transmission power or the repetition factor for the at least one of the SSB or the SIB1.

29. A method of wireless communication performable at a user equipment (UE), comprising:
sending, to a network entity, an uplink signal requesting transmission of at least one of a synchronization signal block (SSB) or a system information block type 1 (SIB1), the uplink signal indicating a transmission parameter for the at least one of the SSB or the SIB1, the transmission parameter being at least one of a transmission power or a repetition factor; and
obtaining the at least one of the SSB or the SIB1 associated with the transmission parameter based at least in part on the uplink signal.

30. A method of wireless communication performable at a network entity, comprising:
obtaining, from a user equipment (UE), an uplink signal requesting transmission of at least one of a synchronization signal block (SSB) or a system information block type 1 (SIB1), the uplink signal indicating a transmission parameter for the at least one of the SSB or the SIB1, the transmission parameter being at least one of a transmission power or a repetition factor; and
sending the at least one of the SSB or the SIB1 associated with the transmission parameter based at least in part on the uplink signal.
